(19) United States
(12) Patent Application Publication
(10) Pub. No.: US 2015/0186975 A1
(43) Pub. Date: Jul. 2, 2015

(54) PRODUCT MATCHING SYSTEMS AND RELATED METHODS

(71) Applicant: Viesoft, Inc., San Francisco, CA (US)

(72) Inventor: Anthony Vierra, San Francisco, CA (US)

(73) Assignee: Viesoft, Inc., San Francisco, CA (US)

(21) Appl. No.: 14/145,474

(22) Filed: Dec. 31, 2013

(51) Int. Cl. G06Q 30/06

(52) U.S. Cl. CPC G06Q 30/0627

(57) ABSTRACT

Systems and methods are described for retrieving, from various online retail websites, product listings and associated pricing information for particular product. The system may be configured to receive a request, from a user, to view pricing information for a particular product from one or more websites hosted by the user's competitors. The request may include one or more matching criteria for identifying the one or more matching product listings. In various embodiments, the system is configured to: (1) determine one or more potentially matching product listings based at least in part on the matching criteria; (2) enable the user to confirm that the one or more potentially matching product listings are one or more matching product listings; (3) determine pricing information for the one or more matching product listings; and (4) display the pricing information to the user.

### BACKGROUND

Retailers typically desire to price products that they offer for sale in a way that makes them competitive with other retailers. Also, manufacturers and other entities often have a need to monitor the pricing of their products. Because products are typically sold by a variety of different entities in different venues, it is often difficult and time consuming to obtain current pricing information. Accordingly, there is currently a need for improved systems for tracking the pricing of products, especially the pricing of products that are offered for sale on-line, which may include varying descriptions and details for the same products.

### SUMMARY

A computer system, according to various embodiments, comprises at least one processor. In particular embodiments, the computer system is configured for: (A) receiving a request for pricing information for a particular product, the request comprising one or more matching criteria for use in identifying one or more product listings for the particular product; (B) receiving a plurality of product listings from a plurality of online retail websites; (C) determining, based at least in part on the one or more matching criteria, which of the plurality of product listings are one or more potentially matching product listings; (D) providing a listing of the one or more potentially matching product listings to a user; (E) enabling the user to confirm that the one or more potentially matching product listings are one or more product listings for the particular product; (F) determining pricing information for the one or more confirmed product listings; and (G) providing the pricing information to the user.

A computer-implemented method for displaying pricing information for one or more matching product listings for a particular product, according to particular embodiments, comprises: (A) receiving, by a processor, a first request to retrieve one or more matching product listings for a particular product, the request comprising: a first matching criteria value associated with a first product field; and a first filter associated with the first product field; (B) at least partially in response to the first request, retrieving, by a processor, based at least in part on the first matching criteria value and the first filter, one or more potentially matching product listings for the particular product; (C) displaying, by a processor, the one or more potentially matching product listings to a user; (D) receiving, by a processor, from the user, a first indication that the one or more potentially matching product listings are one or more product listings for the particular product; (E) at least partially in response to receiving the first indication, associating, by a processor, the confirmed one or more potentially matching product listings with the one or more matching product listings; (F) receiving, by a processor, a second request to display pricing information associated with the one or more matching product listings; and (G) at least partially in response to the second request: retrieving, by a processor, the pricing information; and displaying, by a processor, the pricing information to the user.

A non-transitory computer-readable medium, according to various embodiments, stores computer-executable instructions for: (A) enabling a user to submit one or more matching requests for pricing information for one or more particular products, each of the one or more matching requests comprising one or more matching criteria; (B) receiving a first matching request for pricing information for a first particular product from the user, the first matching request comprising one or more first matching criteria; (C) receiving one or more product listings from a plurality of online retail websites; (D) at least partially in response to receiving the first matching rule, determining, based at least in part on the one or more first matching criteria, which of the one or more of product listings are one or more potentially matching product listings for the first particular product; (E) enabling a user to confirm that the one or more potentially matching product listings are one or more product listings for the first particular product; (F) determining pricing information associated with the one or more confirmed product listings; and (G) displaying the pricing information to the user.

### BRIEF DESCRIPTION OF THE DRAWINGS

Various embodiments of a system and method for matching product listings are described below. In the course of this description, reference will be made to the accompanying drawings, which are not necessarily drawn to scale, and wherein:

FIG. 1 is a block diagram of a product matching server in accordance with an embodiment of the present system;

FIG. 2 is a schematic diagram of a computer, such as the product matching server of FIG. 1, that is suitable for use in various embodiments;

FIG. 3 depicts a flow chart that generally illustrates various steps executed by a product matching module that, for example, may be executed by the product matching server of FIG. 1;

FIGS. 4-8 are exemplary screen displays of the system according to various embodiments.

### DETAILED DESCRIPTION

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

Systems, according to various embodiments, are adapted to track pricing information in the context of an electronic commerce environment such as the Internet, or other suitable environment. In particular embodiments, the system is adapted to allow a user to define at least one particular product for which the user wishes to dynamically track pricing information. The user then provides matching criteria that the system uses to identify one or more product listings that may potentially be product listings for the particular product. The matching criteria may include, for example: (1) the product's formal name and any equivalents or abbreviations of that name; (2) other alphanumeric product identification information that may be used to identify the product (e.g., the product's make, model, SKU, etc. . . . ); (3) one or more symbols that may be used to identify the product (e.g., one or more logos associated with the product or the product's source); (4) one or more images of the product; and/or (5) any other suitable information that may be used to identify the product.

In addition, the matching criteria may specify one or more locations to discover competing products. For example, the matching criteria may specify one or more retail websites and/or online marketplaces that the system is to search for product listings that may potentially be matching product listings for the particular product.

The matching criteria may also include one or more filters that the user may use to broaden or narrow the search (e.g., on a field by field basis). For example, the matching criteria may include a filter on a product name field that specifies that the search should only return any product listings that have a product name that exactly matches the name of the particular product (or one or more specified abbreviations or variations of the name). Alternatively, the matching criteria may include a broader filter for the product name field specifying that the search return product listings that include a product name that is similar to the name of the particular product (or one or more specified abbreviations or variations of the name). In the examples above, the second set of matching criteria would typically return more product listings than the first set of matching criteria.

After the system receives the matching criteria from the user, the system may use the matching criteria to search for product listings that satisfy the matching criteria. For example, if a search requested the return of any product listings on the www.officeworks.com or www.officemakers.com website that are for a product named (e.g., exactly named) “The Canon Stapler” by PaperProfessionals, the system would search the www.officeworks.com and www.officemakers.com websites to determine whether the web sites include any product listings for a product called “The Canon Stapler”.

In various embodiments, if the system identifies one or more product listings that satisfy the matching criteria, the system retrieves pricing information associated with the product listing (e.g., the price at which the product is offered within the product listing). The system may then display the retrieved product listings (e.g., in the form of a reproduction or summary of the product listings) to a user (e.g., a representative of a particular company or a third party product matching worker) who then determines whether each retrieved product listing is truly for the particular product specified in the matching criteria.

Once a user verifies that a particular listing is a listing for the product specified in the matching criteria, the system may, for example, publish pricing information to a pricing display screen (or other location) for use in tracking (e.g., in real time, or substantially in real time) the current pricing for the product or for use in repricing the product at an online retail store controlled by the user. The system may be configured to update this information on any specified schedule (e.g., hourly, daily, weekly, etc. . . . ). This may, for example, allow a user to view current pricing information for one or more particular products from a variety of different websites (or other sources) on a single screen.

In particular embodiments, the system may be adapted to use the pricing information obtained from the above process to reprice a particular product (e.g., by changing the sale price of the product on a particular retail website or in a particular store). For example, the system may be configured so that, after a user confirms that a product listing on a first specified website is for a particular product (or after the system automatically confirms that the product listing satisfies one or more criteria), the system automatically sets the price of the product on a second website (e.g., a website associated with the user or the user's employer) to match the price of the product specified in the product listing. In other embodiments, the user may configure the system to set the price of the product on the second website so that it is always a certain amount lower or higher than one or more current prices for the product determined using the process outlined above. For example, the user may configure the system to set the product's current price on a retail website to be one cent (or other pre-determined amount) lower (or higher) than the current lowest price found by the system on one or more other retail web sites.

In certain embodiments, the system may be configured to generate one or more alerts in response to determining that pricing for a confirmed or non-confirmed product listing is above, at, or below a certain threshold value. For example, after the system or a user confirms that a product listing is, in fact, a product listing for a particular product, the system may be adapted to compare a current price associated with the product listing with a specified threshold value. The system may be configured to then generate an alert (or execute any other suitable steps) in response to the determining that the price is lower than the threshold value. Such an alert may include, for example, a visual alert (e.g., a display of the price in a particular color or against a particular background), an audio alert (e.g., an audio alarm), or any other suitable alert.

In particular embodiments, the system may be configured to determine, from one or more product listings, a geography-specific price for the relevant product. For example, the system may be configured to determine that a price for the relevant product is available to users who live in a first geographical region (e.g., one or more particular states) is lower than a specified minimum price for the product within that region. The system may be configured for generating an alert in response to determining that the geography-specific price for the product satisfies certain criteria.

In various embodiments, the system is configured for using one or more advanced techniques for determining whether a particular product listing matches the specified matching criteria. Such criteria may include, for example: (1) matching one or more matching rules from the matching criteria with corresponding foreign language equivalents within candidate product listings (e.g., product listings that are being matched); (2) matching one or more images from within the search with one or more images within candidate product listings; and (3) any other suitable technique. These and other aspects of the system are discussed in greater detail below.

### Exemplary Technical Platforms

As will be appreciated by one skilled in the relevant field, the present invention may be, for example, embodied as a computer system, a method, or a computer program product. Accordingly, various embodiments may take the form of an entirely hardware embodiment, an entirely software embodiment, or an embodiment combining software and hardware aspects. Furthermore, particular embodiments may take the form of a computer program product stored on a computer-readable storage medium having computer-readable instructions (e.g., software) embodied in the storage medium. Various embodiments may take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems) and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, special purpose computer, or other programmable data processing apparatus to produce a machine, such that the instructions which execute on the computer or other programmable data processing apparatus to create means for implementing the functions specified in the flowchart block or blocks.

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

### Example System Architecture

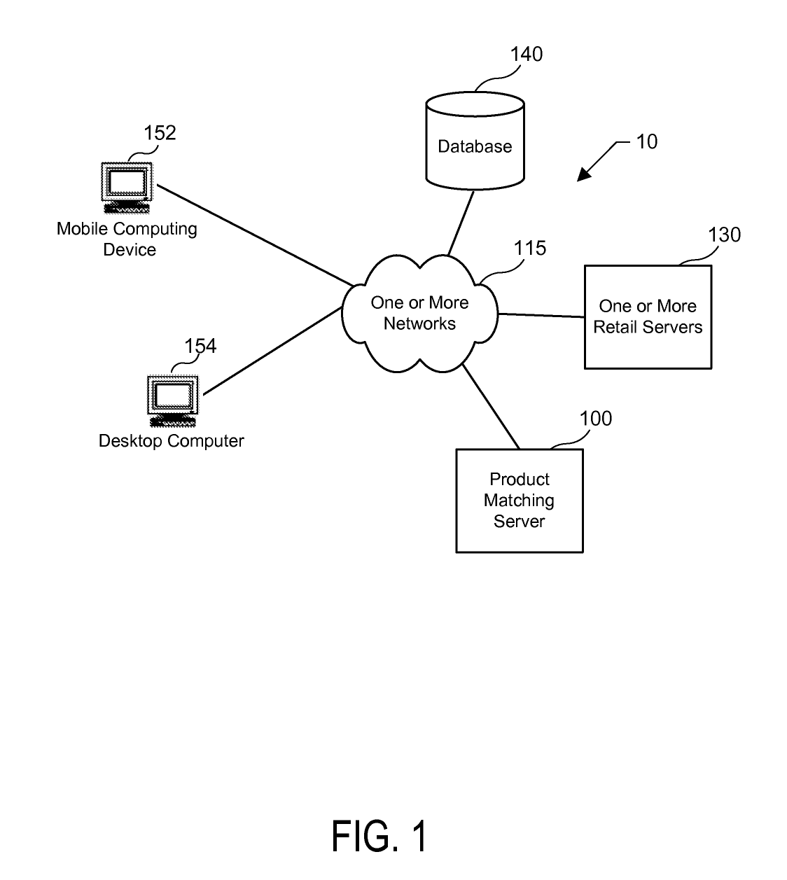

FIG. 1 is a block diagram of a System 110 according to a particular embodiment. As may be understood from this figure, the System 110 includes one or more computer networks 115, a Product Matching Server 100, One or More Retail Servers 130, a Database 140, and one or more remote computing devices such as a mobile computing device 152 (e.g., such as a smart phone, a tablet computer, a wearable computing device, a laptop computer, etc.) or a desktop computer 154. In particular embodiments, the one or more computer networks facilitate communication between the Product Matching Server 100, One or More Retail Servers 130, the Database 140, and the one or more remote computing devices 152, 154.

The one or more computer networks 115 may include any of a variety of types of wired or wireless computer networks such as the Internet, a private intranet, a mesh network, a public switch telephone network (PSTN), or any other type of network (e.g., a network that uses Bluetooth or near field communications to facilitate communication between computers). The communication link between Product Matching Server 100 and Database 140 may be, for example, implemented via a Local Area Network (LAN) or via the Internet.

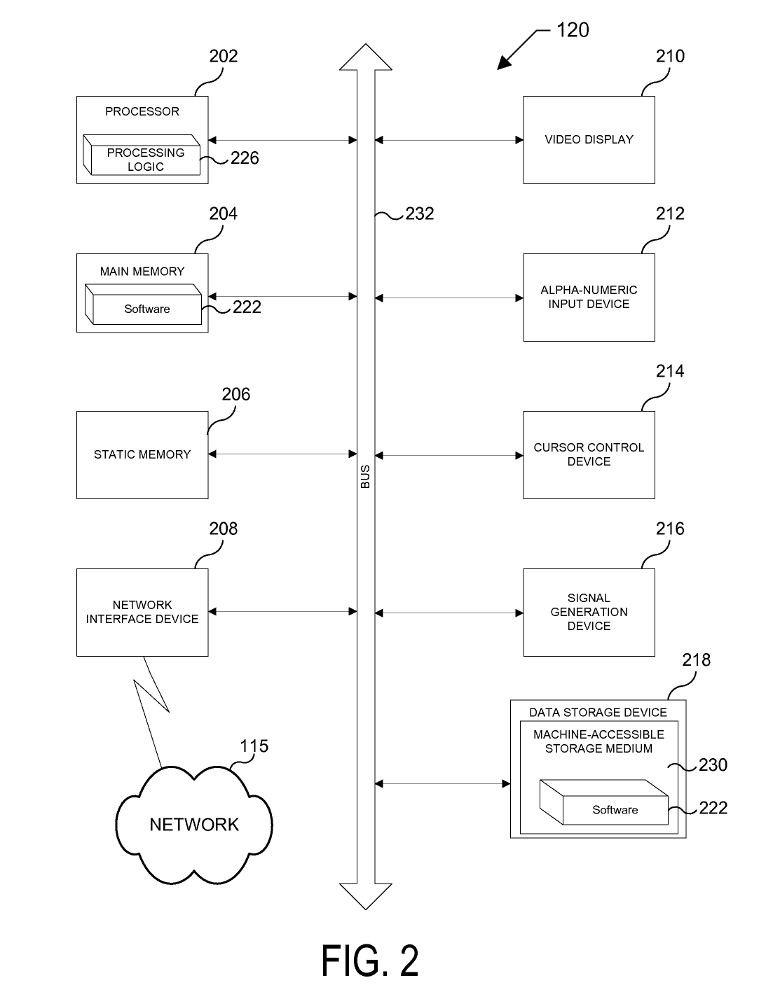

FIG. 2 illustrates a diagrammatic representation of a computer 120 that can be used within the System 110, for example, as a client computer (e.g., one of the remote computing devices 152, 154 shown in FIG. 1), or as a server computer (e.g., Product Matching Server 100 shown in FIG. 1). In particular embodiments, the computer 120 may be suitable for use as a computer within the context of the System 110 that is configured for collecting, tracking, and storing product matching data.

In particular embodiments, the computer 120 may be connected (e.g., networked) to other computers in a LAN, an intranet, an extranet, and/or the Internet. As noted above, the computer 120 may operate in the capacity of a server or a client computer in a client-server network environment, or as a peer computer in a peer-to-peer (or distributed) network environment. The Computer 120 may be a desktop personal computer (PC), a tablet PC, a set-top box (STB), a Personal Digital Assistant (PDA), a cellular telephone, a web appliance, a server, a network router, a switch or bridge, or any other computer capable of executing a set of instructions (sequential or otherwise) that specify actions to be taken by that computer. Further, while only a single computer is illustrated, the term “computer” shall also be taken to include any collection of computers that individually or jointly execute a set (or multiple sets) of instructions to perform any one or more of the methodologies discussed herein.

An exemplary computer 120 includes a processing device 202, a main memory 204 (e.g., read-only memory (ROM), flash memory, dynamic random access memory (DRAM) such as synchronous DRAM (SDRAM) or Rambus DRAM (RDRAM), etc.), a static memory 206 (e.g., flash memory, static random access memory (SRAM), etc.), and a data storage device 218, which communicate with each other via a bus 232.

The processing device 202 represents one or more general-purpose or specific processing devices such as a microprocessor, a central processing unit, or the like. More particularly, the processing device 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 202 may also be one or more special-purpose processing devices such as an application specific integrated circuit (ASIC), a field programmable gate array (FPGA), a digital signal processor (DSP), network processor, or the like. The processing device 202 may be configured to execute processing logic 226 for performing various operations and steps discussed herein.

The computer 120 may further include a network interface device 208. The computer 120 also may include a video display unit 210 (e.g., a liquid crystal display (LCD) or a cathode ray tube (CRT)), an alphanumeric input device 212 (e.g., a keyboard), a cursor control device 214 (e.g., a mouse), and a signal generation device 216 (e.g., a speaker).

The data storage device 218 may include a non-transitory computer-accessible storage medium 230 (also known as a non-transitory computer-readable storage medium or a non-transitory computer-readable medium) on which is stored one or more sets of instructions (e.g., software 222) embodying any one or more of the methodologies or functions described herein. The software 222 may also reside, completely or at least partially, within the main memory 204 and/or within the processing device 202 during execution thereof by the computer 120—the main memory 204 and the processing device 202 also constituting computer-accessible storage media. The software 222 may further be transmitted or received over a network 115 via a network interface device 208.

While the computer-accessible storage medium 230 is shown in an exemplary embodiment to be a single medium, the terms “computer-accessible storage medium” and “computer-readable medium” should be understood to include a single medium or multiple media (e.g., a centralized or distributed database, and/or associated caches and servers) that store the one or more sets of instructions. The terms “computer-accessible storage medium” and “computer-readable medium” should also be understood to include any medium (e.g., non-transitory medium) that is capable of storing, encoding or carrying a set of instructions for execution by the computer and that cause the computer to perform any one or more of the methodologies of the present invention. The terms “computer-accessible storage medium” and “computer-readable medium” should accordingly be understood to include, but not be limited to, solid-state memories, optical and magnetic media, etc.

### Exemplary System Platform

As noted above, systems, according to various embodiments, are adapted to track pricing information in the context of an electronic commerce environment such as the Internet, or other suitable environment. The system may then use this pricing information in any suitable way (e.g., the system may facilitate re-pricing of a particular product so the product priced in a way that is consistent with current market conditions, or the system may be used by a company's legal department to assure that products are being sold at prices that are consistent with the company's contractual pricing obligations.) Various aspects of the system's functionality may be executed by certain system modules, including a Product Matching Module 300. This module is discussed in greater detail below.

Product Matching Module

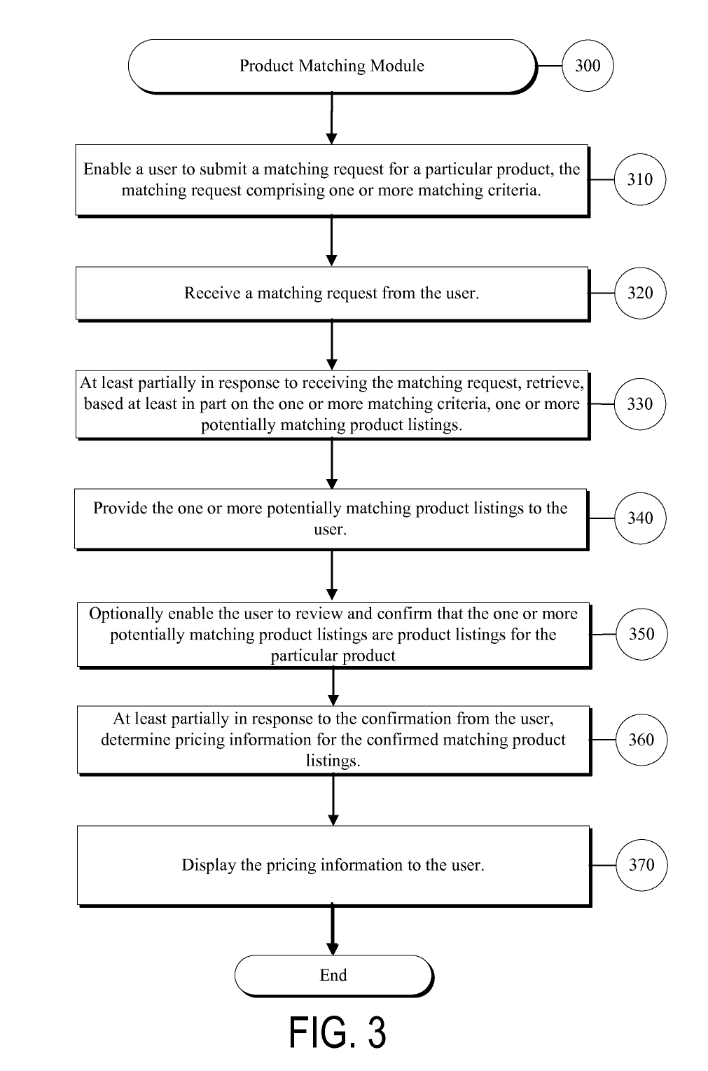

FIG. 3 is a flow chart of operations performed by an exemplary Product Matching Module 300, which may, for example, run on the product matching server 100, or any suitable computing device (such as a suitable mobile computing device). In particular embodiments, the Product Matching Module 300 may facilitate retrieval of one or more product listings and associated pricing information for a particular requested product, for example, from a plurality of online retail websites.

In various embodiments, the system begins, at Step 310, by enabling a user to submit a matching rule for a particular product, the matching rule comprising one more matching criteria. In particular embodiments, the system may be configured to enable the user to submit the matching rule using any suitable computing device. In various embodiments, the one or more matching criteria may include one or more matching criteria values for one or more fields having one or more associated filters. The fields, matching criteria values, and filters that may make up a particular matching rule are discussed more fully below:

One or More Fields

In particular embodiments, the one or more fields within a particular matching rule may include the name of the particular product (e.g., a product name field), an image of the particular product (e.g., an image field), a stock keeping unit (SKU) associated with the particular product (e.g., an SKU field), a brand of the particular product (e.g., a brand field), etc. In other embodiments, the one or more fields that make up a particular matching rule may include any suitable combination of these one or more fields or any other suitable fields.

One or More Matching Criteria Values

In particular embodiments, the system is configured to enable the user to provide one or more matching criteria values for each of the one or more fields that make up a particular matching rule. In various embodiments, the one or more matching criteria values may comprise one or more characters (e.g., one or more alphanumeric characters) and/or symbols. In various embodiments, the one or more matching criteria values provided by the user for a particular field may include a set of matching criteria values. In the case of a product brand field, for example, the system may enable the user to provide associated matching criteria values that may include, for example, a plurality of product brands. For example, a particular brand may have a plurality of naming and spelling conventions. In such a case, the user may submit matching criteria values for the product brand name field that includes any of the various names used for the particular brand by providing each of the various names as part of the matching criteria values in a ‘product brand’ field of the matching rule. In another example, a product may be sold under multiple SKUs or UPCs or have different product names or nicknames. In this example, a matching rule may include matching criteria values that includes all known names, UPCs, SKUs, etc. for a particular product. For example, the system may enable the user to submit a matching rule that comprises both “Microsoft” and “MS” as matching criteria values for a product brand field, and that comprises “Surface” and “Surface Tablet” as matching criteria values for a product model field, etc.

One or More Filters

In particular embodiments, the matching rule includes one or more filters associated with one or more particular fields referenced within the matching rule. In various embodiments, the one or more filters may include rules for searching for product listings based at least in part on one or more matching criteria values for the one or more fields including, for example, product name, brand name, model number, and/or SKU, etc. The one or more filters may include rules for how closely one or more potentially matching product listings (e.g., one or more product listings that the system may determine are product listings for the particular product) match the corresponding matching criteria for the requested particular product.

In various embodiments, the system may enable the user to provide any of a variety of different filters for the one or more matching criteria values for the one or more fields referenced within a particular matching rule. The one or more filters may include, for example: (1) a “no criteria” filer; (2) an “any matching criteria” filter (which may, for example, have a relatively low matching requirement); (3) a “similar matching criteria” filter (which may, for example, include product listings that are more similar to the requested product listings but that may not be identical to the requested product listings); and (4) an “exact matching criteria” filter (which may include one or more product listings that exactly match the requested product listing). These criteria are discussed more fully below.

“None Matching Criteria” Filter

In particular embodiments, the system is configured to enable the user to select a “none matching criteria” filter for a specified field referenced in a matching rule for a particular product. In such cases, the system will not filter target product listings based on the specified field.

“Any Matching Criteria” Filter

In various embodiments, a matching rule having matching criteria for a particular field with an associated “any matching criteria” filter specifies that the matching criteria values for the particular field must at least partially match the value in a corresponding field in a particular product listing in order to be returned as part of the results of the matching rule. A matching rule that includes an “any matching criteria” filter for a particular field may include, for example, a request to return one or more potential matching product listings where the data in the corresponding field for the one or more potential matching product listings match at least a subset of characters that make up the particular matching criteria value. For example, where a request includes a matching criteria value for an SKU field for a product with an associated “any matching criteria” filter, the matching rule may return one or more potential product listings having data in an SKU field that matches at least a particular number of characters that make up the matching criteria value for the SKU field. In a particular example, an “any matching criteria” filer may seek to match only one character, only two characters, or any other predetermined number of characters. In other embodiments, the request is a request to match between about 5 percent and about twenty-five percent of the characters (e.g., or any other suitable percentage or fraction) that make up a particular matching criteria value.

In some embodiments, the request is a request to match one or more characters where the one or more characters are consecutive characters or, alternatively, characters that are not adjacent one another. For example, in a request including an SKU field where the matching criteria value includes the string “XY”, the matching rule may return one or more product listings with an SKU that includes the characters X and Y even if the X and the Y are not adjacent one another in the SKU. Although this filter is described in relation to an SKU, it should be understood that an “any matching criteria” filter may be applied to any matching criteria value for any field within a matching rule for a particular product.

“Similar Matching Criteria” Filter

In particular embodiments, a matching rule having a similar matching criteria filter for a particular field specifies that the matching criteria value for a particular field must at least substantially match the value in a corresponding field in a particular product listing in order to be returned as part of the results of the matching rule. Matching criteria having a similar matching criteria filter may include, for example, a request to return one or more potential matching product listings where the data in the corresponding field of the one or more potential matching product listings substantially matches one or more characters of the matching criteria value for the particular field from the matching rule. In particular embodiments, a request for a “similar” match includes a request to match four or more characters of a matching criteria value for the particular field (e.g., four or more characters of a brand name). In a particular example, various brand names may have different spelling conventions or abbreviations (e.g., HP for Hewlett Packard). In such embodiments, a request for a particular brand name under a similar matching criteria filter may return one or more product listings that include one or more product listings having a brand name that is similar to the requested brand name (e.g., the one or more product listings may include product listings having the same brand under a different naming convention).

Exact Matching Criteria Filter

In various embodiments, an “Exact Matching Criteria” filter specifies that the matching criteria value for a particular field must exactly match the value in a corresponding field in a particular product listing in order to be returned as part of the results of the matching rule. In such embodiments, the request includes a request to retrieve one or more product listings having a value for a particular field that exactly matches a matching criteria value for the particular field from the matching rule. As a particular example, if a matching rule includes a particular SKU, the requester only desires to see pricing information for any product listings that include the exact particular SKU.

In various embodiments, a matching rule may include different filters for particular fields associated with a matching rule for a particular product. For example, the system may receive a request for pricing information for a particular product, where the matching rule includes the following fields: (1) a product brand with an associated first filter; (2) a product name with an associated second filter; and (3) an SKU with an associated third filter. In this example, the first filter may be an “exact criteria” filter (e.g., the request is a request for pricing information for products having the exact same product brand as the particular product); the second filter may be an any matching criteria filter (e.g., the request is a request for pricing information for products that at least partially match a product name specified in the matching rule); and the third filter may be a no criteria filter (e.g., the request is a request for pricing information regardless of SKU).

In particular embodiments, the system may further enable the user to provide one or more retailers from which the user would like to retrieve potentially matching product listings. In various embodiments, the system may be configured to receive a selection of the one or more retailers from which the user is requesting the one or more product listings as part of the matching rule. In various embodiments, the system may enable the user to select the one or more retailers from a listing of known retailers. In other embodiments, the system may enable the user to provide one or more names or one or more URLs for the one or more retailers as part of the matching rule.

Returning to Step 320, the system continues by receiving the matching rule from the user. In various embodiments, the system may receive the matching rule from the user seeking pricing information for the particular product, for example, to determine a suitable price at which to offer the particular product for sale (e.g., in order to price the particular product competitively with others selling the particular product). In other embodiments, a user may seek pricing information for the particular product, for example, to ensure that one or more retailers are complying with specified (e.g., minimum) advertised pricing requirements for the product. In particular embodiments, the system is configured to receive the matching rule in response to input, by the user, via an input device associated with a suitable computing device (e.g., such as a suitable mobile computing device).

Next, at Step 330, the system continues by, at least partially in response to receiving the matching rule at Step 320, retrieving, based at least in part on the matching rule, one or more potentially matching product listings. In various embodiments, the one or more potentially matching product listings include one or more product listings for products that are potentially the same as the particular product specified in the matching rule.

As may be understood form this disclosure, different retailers may have a product listing for a particular product that at least partially differs in descriptive content from a product listing for the same particular product from a different retailer. For example, a first particular retailer may have a product listing for a particular model of tablet computer that has a description of “iPad”, while a second particular retailer has a product listing for the same particular model of tablet computer that includes a description of “White 64 GB 4G enabled iPad”. One or more other retailers may have one or more product listings that are similar for different products. Continuing the example immediately above, a third particular retailer may have a product listing for a different model of tablet computer that has a description of “iPad” as well.

In various embodiments, the system may retrieve the one or more potentially matching product listings from any suitable source, such as, for example, from one or more online retail websites, one or more suitable databases of product listings and pricing information, or any other suitable source. In a particular embodiment, the system is configured to retrieve data from one or more product listings, and to compare the data to the various matching criteria values. In various embodiments, the system may be configured to retrieve the one or more potentially matching product listings from, for example, one or more particular competitor web sites, one or more particular companies, etc. In other embodiments, the system is configured to retrieve the one or more potentially matching product listings from one or more sources provided by the user as part of the matching rule (e.g., from one or more retailer web sites selected by the user when submitting the matching rule). In various embodiments, the system is configured to retrieve the one or more potentially matching product listings by determining a single product listing that most closely matches the matching rule for each particular source (e.g., for each particular online retailer that the system discovers the one or more potentially matching product listings).

In various embodiments, the system is configured to retrieve the one or more potentially matching product listings by: (1) retrieving one or more product listings from a particular retailer; and (2) determining which of the one or more product listings satisfy the matching criteria included in the user's matching rule. The system may do this in any suitable manner. For example, the system may search all product listings on Amazon.com in response to a request for a product search having a particular product name with a “similar” matching criteria filter. The system may then retrieve the product listing on Amazon.com that is the most similar to the requested product name. In other embodiments, the system may discover all product listings on Amazon.com that have a product name that is at least a similar match to the particular product name.

The system continues at Step 340 by providing the one or more potentially matching product listings to the user. The system may provide the one or more potentially matching product listings to the user, for example, by displaying the one or more potentially matching product listings to the user on a display of the computing device from which the user submitted the matching rule at Step 310. In other embodiments, the system may provide the one or more potentially matching product listings via another suitable computing device, via e-mail, via text message, or in any other suitable manner. In various embodiments, the system displays potentially matching product listings in a chart or table that is displayed on a computer display associated with the user.

Continuing at Step 350, the system enables the user to optionally confirm that the one or more potentially matching product listings are product listings for the particular product. The system may enable the user to confirm this by enabling the user to indicate (e.g., using a mouse, keyboard, or other suitable input device) whether any particular product listing of the one or more potentially matching product listings provided to the user at Step 340 is in fact a product listing for the particular product. In various embodiments, one or more of the one or more potentially matching product listings may include one or more product listings that are for a product other than the particular product (e.g., because the request for pricing information included a matching rule having one or more fields and matching criteria values with a less stringent associated filter such as an “any matching criteria” filter, etc.). In various embodiments, the system is configured to blacklist the potentially matching product listings that the user indicates are not a match (e.g., the system may be further configured to not include such product listings as potential matches for a particular product for future similar requests).

In particular embodiments, the system is configured to substantially automatically determine that one or more product listings retrieved at Step 330 are product listings for the user's specified product, and then enable the user to confirm the remaining, undetermined one or more product listings are matches or not. For example, the system may be configured to substantially automatically determine that a product listing that is an exact match to the matching rule is a product listing for the requested particular product, while providing one or more product listings that are not exact matches to the user for confirmation. In such embodiments, the system may be configured to whitelist one or more product listings that the user has confirmed from the one or more potentially matching product listings (e.g., the system, in response to a future similar request, would substantially automatically confirm that the one or more confirmed potentially matching product listings are matches rather than providing them to the user again for confirmation).

At Step 360, the system, at least partially in response to the confirmation from the user, determines pricing information for the one or more confirmed matching product listings. The system may determine pricing information for the one or more confirmed matching product listings by, for example, retrieving the pricing information for each confirmed matching product listing. In particular embodiments, the system may determine pricing information, for example, based at least in part on information provided in a buy box or similar pricing display within a particular product listing. A particular product listing on a particular retail web site may, for example, including pricing information from which the system may obtain a price (e.g., by searching a particular product listing page for a currency symbol such as “$”, etc.). In other embodiments, the system may be configured to retrieve the pricing information from confirmed matching product listings. The system then, at Step 370, displays the pricing information to the user. The system may display the pricing information in any suitable manner such as via a suitable chart or graph. In various embodiments, the system is configured to display historical pricing information (e.g., pricing information over time) for particular product listings.

In various embodiments, the system is configured to store confirmed matching product listings for a particular matching rule in a suitable database from which the system may later retrieve updated pricing information for the confirmed matching product listings. In particular embodiments, the system is configured to enable the user to associate a matching rule for which one or more matching product listings have been confirmed with an account of the user. The system may further be configured to enable the user to log into the account to retrieve updated pricing information for confirmed matching product listings associated with various queries. In other embodiments, the system is configured to substantially automatically retrieve updated pricing information for a particular stored matching rule at a particular interval (e.g., every day, every two days, once per week, once per hour, or any other suitable interval). The system may retrieve updated pricing information, for example, by accessing the one or more matching product listings (e.g., from one or more live web sites), retrieving substantially current pricing information, and updating the associated pricing information sorted by the system to reflect the current pricing information. In such embodiments, once the system receives the matching rule at Step 320 and the one or more confirmed matching product listings are established, the system may substantially automatically track changes in pricing information for the one or more confirmed matching product listings and provide the tracked pricing information to the user (e.g., in real time, or substantially in real time).

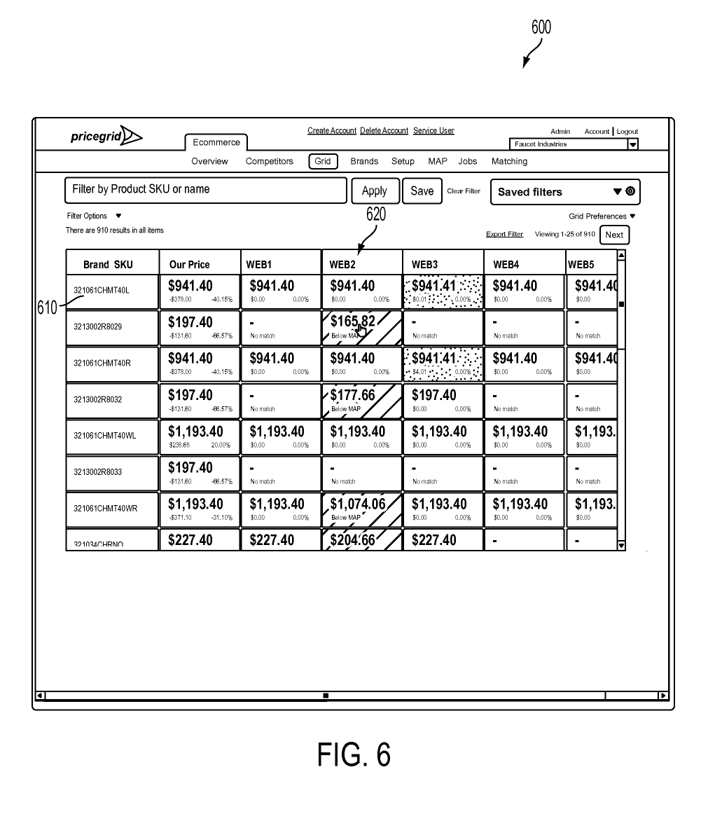

In various embodiments, the system is configured to associate the confirmed matching products (e.g., or services) with an account associated with a particular user. In such embodiments, the system may then be configured to provide the particular user with access to the account (e.g., via a suitable computing device) where the user can view pricing information for any product for which the user has requested pricing information. In this example, the system may update pricing information for various product listings for the particular product substantially automatically for display to the user. As shown in FIG. 6, the system may provide a user with an interface 600 that displays pricing information for various requested products associated with the user's account. The interface 600 may include a column of requested products 610 associated with the user's account in a chart with pricing information 620 from various retailers. Each pricing information column 620 may include pricing information from a particular online retail website.

In particular embodiments, the system is configured to substantially automatically adjust pricing of a product listing based at least in part on the retrieved pricing information. In various embodiments, a company associated with the user may have its own product listing for the particular product, for example, on a website controlled by the user. In such embodiments, the system may substantially automatically adjust a price of the particular product within this product listing.

In other embodiments, the system may substantially automatically generate an alert and/or a non-compliance report in response to determining that pricing information for one of the one or more confirmed matched product listings satisfies one or more predetermined criteria (e.g., the price is above or below a particular threshold price, such as a minimum allowable sale price). In a particular application, a particular retailer may have an agreement with a product supplier not to sell the product below a particular price. The system may enable product suppliers to keep track of retailers selling their product under such an agreement to ensure that the retailer is abiding by the agreement. The system may be configured to substantially automatically transmit a non-compliance report (or other suitable correspondence) to the offending retailer or provide the non-compliance report to a user for transmission to one or more non-compliant entities responsible for the one or more product listings.

### Exemplary User Experience

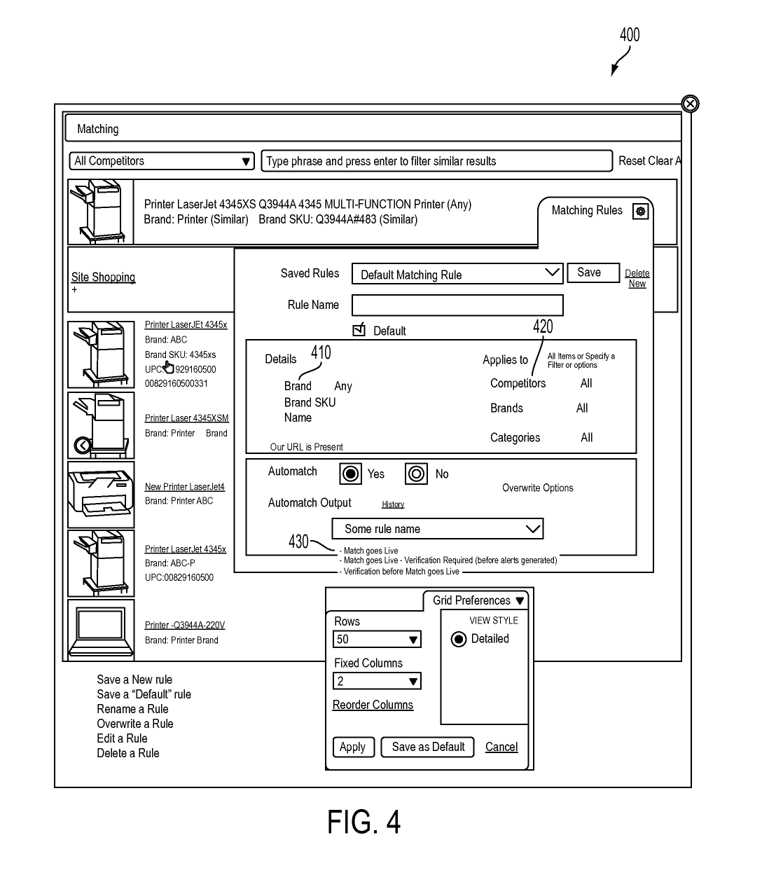

FIGS. 4-8 depict exemplary screen displays that show a graphical user interface associated with a system according to a particular embodiment. As noted above, a user may be, for example, a brand manager within the marketing branch of a large online retailer who is in charge of a particular product line, an employee of a manufacturer tasked with monitoring retailers for minimum advertised price violations, or any other suitable user. However, the system may be configured for use by any other suitable user.

FIG. 4 depicts a user interface 400 that a user may use to define a matching rule for pricing information for a particular product. As may be understood from this figure, the user may provide one or more matching criteria values for one or more particular fields 410 associated with the product. As discussed above, the user may also specify a filter for each field, which defines how broadly or narrowly the system will be in identifying matches for the field. In FIG. 4, the user has set up a matching rule for product listings that have: (1) any name; (2) a brand that is similar to “Printer”; and (3) an SKU that is similar to “Q3944A#483”. In this example, the user is relying primarily on the product's SKU to define the search and is using the brand name as a secondary filter for the search. The user may also filter the results based on the competitor offering the product for sale, the category of the product on a particular website, or—in other embodiments—on any other suitable factor.

In the embodiment shown in this figure, the system is further configured to enable the user to select an output 430 for the results of the matching rule. The user may, for example, select to substantially automatically reprice their own listing for the product (e.g., on a retail website that their company controls) based on pricing information obtained from the matching rule. In other embodiments, the user may select to have the system substantially automatically reprice their company's own product listing following manual confirmation by the user (or other individual) that repricing is appropriate. In various embodiments, the individual making this determination may be a representative of a company such as an online retail website, product manufacturer, or any other suitable company. In particular embodiments, the user may include an in-house user associated with the company. In other embodiments, the company may outsource product listing confirmation, repricing acceptance, and/or any other user provided input to one or more outside companies.

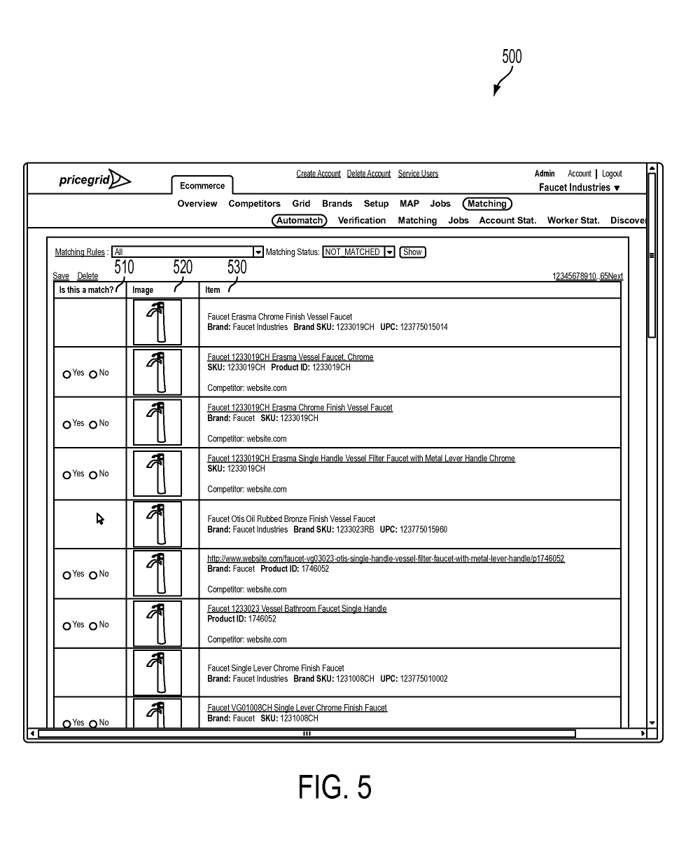

FIG. 5 depicts a user interface 500 that a user may use to confirm one or more potentially matching product listings retrieved by the system. As may be understood from this figure, the interface 500 may include one or more radio buttons adjacent the various product listings in an “Is this a match?” column 510 that the user may use to select whether one or more particular potentially matching product listing are, in fact, one or more listings for the requested product. The interface may further include an image 520 from the one or more potentially matching product listings (if they includes an image), as well as a description of the item 530 as it appears in the one or more potentially matching product listings. After reviewing the information from the product listings, the user may use the radio buttons to indicate whether each product listing truly matches the target product.

FIG. 6 shows a user interface 600 that displays pricing information for various requested products. The interface 600 includes a column of requested products 610 (listed by SKU) within a table that shows a current price that the user's company is currently charging for the product along with the prices that competing companies are charging for the product. For example, the first row of the table shows that the user's company is currently charging $941.40 for a product having an SKU of 321061 CHMT40L, while the competitor WEB1 currently also charging $941.40 for the product and the company's competitor WEB2 is currently charging $941.41 for the product. Some cells within the table are left blank, indicating that no match was found for the product at the indicated retail site.

As may be understood from this figure, the table may include supplemental visual indicia that may be used to indicate, for example: (1) that a competitor's price is below the company's current price; (2) that a competitor's price is above the company's current price; or (3) that a competitor's price is above, at, or below a specified threshold price. For example, in FIG. 6, prices that are below the company's current price are shown against a background of diagonal lines, and prices that are above the company's current price are shown against a dotted background. However, it should be understood that any other methodology may be used to visually alert the user to pricing differences.

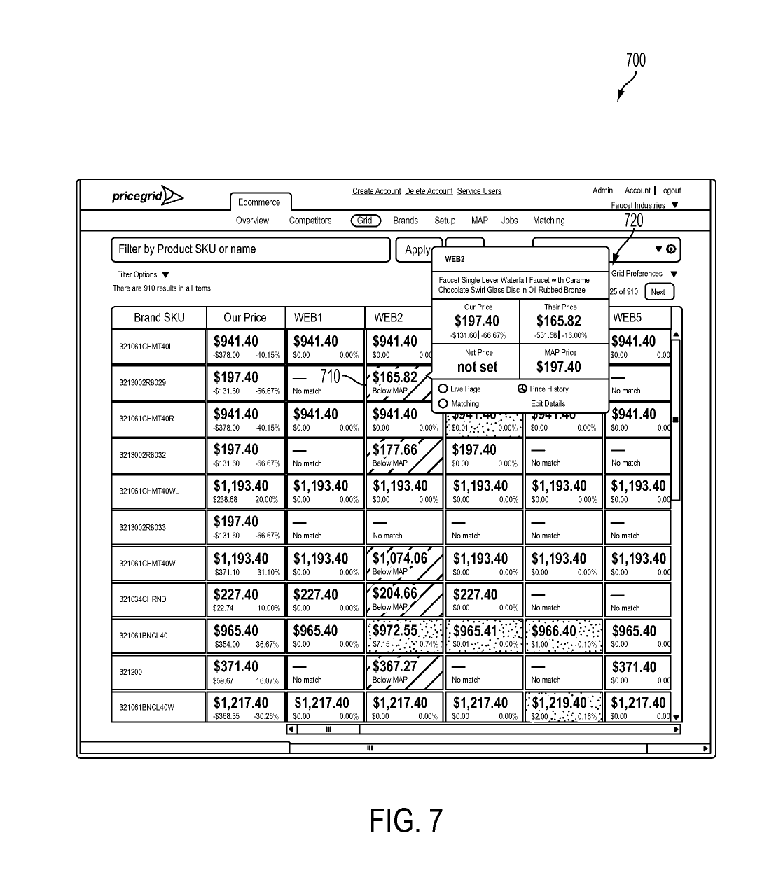

FIG. 7 depicts an interface 700 in which a user has selected pricing information 710 for a particular product at a particular online retail website (e.g., WEB1.com). As shown in this figure, the system displays additional information 720 about that particular product listing such as, for example, the price in comparison to a price at which the user or the user's company offers the product, a minimum advertised price (a “MAP” price), a price history, a link to the particular product listing, etc. This screen may be helpful to users in determining, for example, whether a particular retailer is in violation of an agreement that specifies minimum advertised pricing.

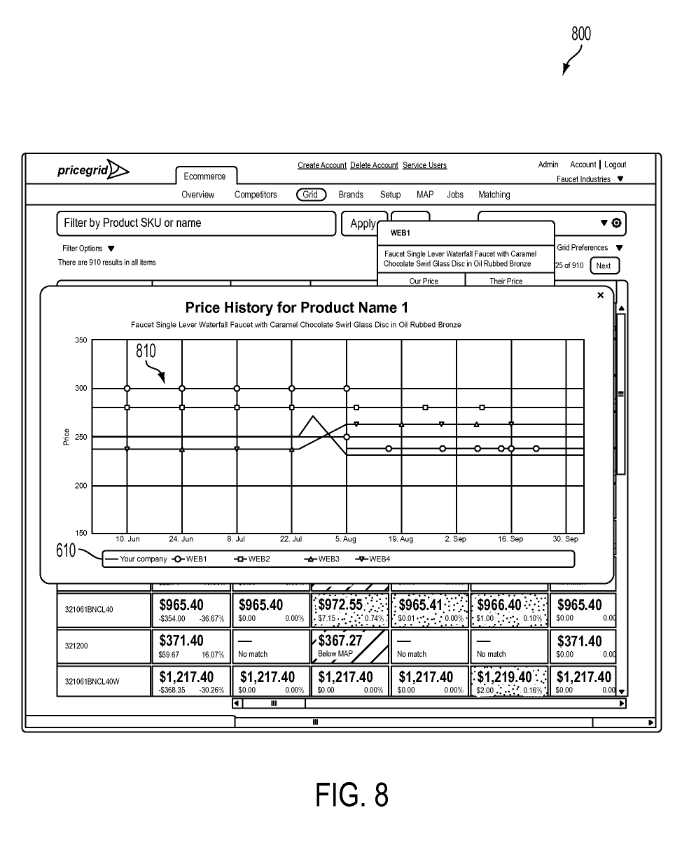

FIG. 8 is a screen display 800 depicting a graph 810 of historical pricing data for a particular product from a plurality of retailers. As shown in this figure, the graph 810 includes pricing data over time for each of a plurality of online retailers. This graph 810 may provide a user with pricing trend information for a particular product.

### Alternative Embodiments

### Matching Based on Synonyms of Matching Criteria Values

In particular embodiments, the system is configured to retrieve matching product listings based at least in part on synonyms of one or more matching criteria values specified in a particular matching rule. For example, a matching rule for a particular brand of sneaker may be set up to return product listings having a product name of “Intense Shoes”. In particular embodiments, the system may be configured to allow a user to expand the matching rule by specifying that the system should also return any listings that includes synonyms of the word “Shoes” (e.g., footwear, etc. . . . ). In various embodiments, the system is configured to determine synonymous words based at least in part on a dictionary, which may for example, be associated with a category of a particular requested product (e.g., a dictionary specific to a particular industry). In various embodiments, the system is configured to enable a user to define a synonym dictionary based at least in part on particular products for which they are requesting pricing information (e.g., particular types of products, etc.).

In particular embodiments, the system is configured to receive, from the user or other suitable source, a dictionary of synonyms related to an industry in which the user is seeking pricing information for products. The system may then associate the dictionary of synonyms with one or more queries associated with the user. The system may then use the dictionary to identify additional matching terms for matching rule, as outlined above, based on the original matching criteria specified within the matching rule.

In various embodiments, the system is configured to retrieve product listings in response to a matching request that may be run against data (“e.g., product listing data”) that is in a foreign language. For example, the system may receive a matching request that includes a request to search a foreign language retail website for matching product listings. The system may be configured to translate matching criteria within a matching rule in order to search for and retrieve product listings for the particular requested product on foreign language web sites and other locations. Alternatively, the system may use a foreign language dictionary to identify one or more synonyms for matching criteria as specified above.

In embodiments in which the system is discovering products on foreign language websites for potentially matching product listings, the system may be configured to automatically determine the language of the retail web site (e.g., by searching for one or more common foreign language words on the website), and, in response to determining that the web site is in a particular foreign language, using a dictionary of the particular foreign language to identify synonyms for the site as specified above.

Regional Pricing

In particular embodiments, the system may enable a user to provide particular regions from which to retrieve pricing information (e.g., North America, Europe, etc.). A user may, for example, limit retrieved pricing information to a particular country, continent, state, city, county, zip code, etc. In various embodiments, the system may receive preferred geographic areas as part of a matching rule from a user. In other embodiments, the system may be configured to retrieve pricing information based at least in part on other geographic considerations, such as, for example, portions of a particular country or continent, areas with one or more particular climates or weather, or any other suitable geographic consideration.

In particular embodiments, the system is configured to retrieve pricing information for one or more product listings for one or more particular retailers where the pricing information may, for example, vary based on region. For example, some retailers may offer one or more products at different prices based at least in part on a location from which a customer's computer accesses the retailer's website. In such embodiments, the system may be configured to provide pricing information to the user that includes the pricing information for the one or more regions or geographic locations.

In particular embodiments, the system is configured to retrieve region-specific pricing information for a particular region by: (1) accessing a computer within the particular region; (2) using the computer to access a particular retail website; and (3) retrieving pricing information from the particular retail website that is specific to the particular region. The system may then use this information to compile pricing information for the particular region.

Image Matching

In particular embodiments, the system is configured to retrieve pricing information in response to a matching rule that specifies an image for matching criteria for a particular product. In various embodiments, the matching rule may include a suitable image file (e.g., jpeg, tiff, etc.) that includes one or more images to be used as part of the matching rule. In various embodiments, the image may include a photograph of the particular product. The system may, for example utilize any suitable image matching techniques to discover potentially matching product listings that include the provided image of the requested product. The system may, for example, determine whether any potentially matching product listings include at least a portion of the provided image (e.g., a cropped version of the provided image, etc.), or determine whether a hash value associated with the provided image matches a hash value of an image file associated with the particular product listing. In other embodiments, the system may use any other suitable technique to compare the provided image with an image associated with a potentially matching product listing.

Marketplace Pricing Retrieval

In various embodiments, the system is configured to determine pricing information for one or more retailers based on one or more product listings that are part of an online shopping marketplace. For example, various online marketplaces may compile pricing information for multiple retailers to provide customers with multiple options from which to purchase a particular product. In particular embodiments, the system is configured to determine pricing information for a particular product based on the one or more product listings in a particular marketplace for the particular product. In some embodiments, the system is configured to automatically determine that the one or more product listings for the particular product in the marketplace are listings for the particular product. In various embodiments, the system is configured to enable the user to confirm (e.g., in the manner discussed above) that any pricing information determined from such a marketplace is pricing information for the particular product.

Matching Configurable Products

In various embodiments the system is configured to determine pricing information for one or more products having one or more particular attributes. For example, a particular product may have one or more attributes such as color, size, fit, etc. Such products may, for example, have a price based at least in part on a particular combinations such product attributes. For example, shoes in a particular size may have a higher price than the same shoe in a smaller size. In other embodiments, a particular product having different one or more attributes may have different shipping options, SKUs, available stock, or other different purchasing information based at least in part on the selected attributes.

In particular embodiments, the system is determined to collect pricing information for a plurality of different configurations of a particular product (e.g., variations of a particular product having different attributes). The system may then display (or otherwise use) this pricing information in any of the ways described above.

In particular embodiments, the system is configured to treat each particular combination of features for a particular product as one or more separate products. For example, for matching purposes, the system may treat a particular shoe in a first color as distinct from the particular shoe in a second color. In other embodiments, the system may match each variety of a particular product for pricing purposes.

### CONCLUSION

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

What is claimed:

1. (canceled)

2. (canceled)

3. (canceled)

4. (canceled)

5. (canceled)

6. (canceled)

7. (canceled)

8. (canceled)

9. (canceled)

10. (canceled)

11. A computer-implemented method for displaying pricing information for one or more matching product listings for a particular product, said method comprising:
(A) receiving, by a processor, a first request to retrieve one or more matching product listings for a particular product, said request comprising:
a first matching criteria value associated with a first product field;
and a first filter associated with said first product field;
(B) at least partially in response to said first request, retrieving, by a processor, based at least in part on said first matching criteria value and said first filter, one or more potentially matching product listings for said particular product;
(C) displaying, by a processor, said one or more potentially matching product listings to a user;
(D) receiving, by a processor, from said user, a first indication that said one or more potentially matching product listings are one or more product listings for said particular product;
(E) at least partially in response to receiving said first indication, associating, by a processor, said confirmed one or more potentially matching product listings with said one or more matching product listings;
(F) receiving, by a processor, a second request to display pricing information associated with said one or more matching product listings;
(G) at least partially in response to said second request: retrieving, by a processor, said pricing information; and displaying, by a processor, said pricing information to said user;
(H) receiving, by a processor, one or more minimum advertised pricing requirements associated with said particular product;
(I) determining, by a processor, based at least in part on said one or more minimum advertised pricing requirements, whether said pricing information for said one or more matching product listings conforms with said one or more minimum advertised pricing requirements; and
(J) at least partially in response to determining that said one or more matching product listings do not conform with said one or more minimum advertised pricing requirements, notifying a user of said non-conformation.

12. (canceled)

13. The computer-implemented method of claim 11, wherein said retrieving said pricing information comprises retrieving said pricing information for a particular geographic area.

14. The computer-implemented method of claim 13, wherein said retrieving said pricing information for said particular geographic area comprises:
identifying a remote computer that is within said particular geographic area;
facilitating using said remote computer to retrieve said pricing information; and
receiving said pricing information from said remote computer.

15. The computer-implemented method of claim 11, wherein:
said method further comprises:
(K) using a one or more thesauruses to determine one or more synonyms of said first matching criteria value; and
said step of retrieving, by a processor, based at least in part on said first matching criteria value and said first filter, one or more potentially matching product listings for said particular product further comprises retrieving, by a processor, one or more additional potentially matching product listings based at least in part on said one or more synonyms.

16. The computer-implemented method of claim 15, wherein said one or more thesauruses comprise one or more foreign language dictionaries.

17. A non-transitory computer-readable medium storing computer-executable instructions for:
(A) enabling a user to submit one or more matching requests for pricing information for one or more particular products, each of said one or more matching requests comprising one or more matching criteria;
(B) receiving a first matching request for pricing information for a first particular product from said user, said first matching request comprising one or more first matching criteria;
(C) receiving one or more product listings from a plurality of online retail websites;
(D) at least partially in response to receiving said first matching rule, determining, based at least in part on said one or more first matching criteria, which of said one or more of product listings are one or more potentially matching product listings for said first particular product;
(E) enabling a user to confirm that said one or more potentially matching product listings are one or more product listings for said first particular product;
(F) determining pricing information associated with said one or more confirmed product listings;
(G) displaying said pricing information to said user;
(H) receiving an indication that said pricing information has changed;
(I) at least partially in response to receiving said indication, updating said pricing information to reflect said change; and
(J) displaying said updated pricing information to said user;
(K) receiving one or more minimum advertised pricing requirements associated with said first particular product; and
(L) determining, based at least in part on said one or more minimum advertised pricing requirements, whether said pricing information for said one or more confirmed product listings conforms with said one or more minimum advertised pricing requirements;
(M) at least partially in response to determining that said one or more confirmed product listings do not conform with said one or more minimum advertised pricing requirements:
(a) generating one or more non-compliance notifications for said one or more nonconforming confirmed product listings; and
(b) taking an action selected from a group consisting of:
(i) providing said one or more non-compliance notifications to said user; and
(ii) substantially automatically transmitting said one or more non-compliance notifications to one or more individuals associated with said one or more nonconforming confirmed product listings.

18. (canceled)

19. (canceled)

20. The non-transitory computer-readable medium of claim 17, further storing computer-executable instructions for:
(N) receiving one or more pricing rules from said user for a product listing for said first particular product associated with said user; and
(O) substantially automatically adjusting a price of said first particular product in said product listing for said first particular product associated with said user based at least in part on both said one or more pricing rules and said pricing information associated with said one or more confirmed product listings.

21. The non-transitory computer-readable medium of claim 17, wherein said one or more pricing rules comprise a pricing rule for said price of said first particular product in said product listing for said first particular product associated with said user to be no more than a particular amount greater than a lowest price determined from said pricing information associated with said one or more confirmed product listings.

22. The non-transitory computer-readable medium of claim 21, wherein said receiving one or more product listings from said plurality of online retail websites comprises scraping said one or more product listings from said plurality of online retail websites.
